(19) United States
(12) Patent Application Publication
(10) Pub. No.: US 2015/0051715 A1
(43) Pub. Date: Feb. 19, 2015

(54) DEVICE CONTROL SYSTEM

(71) Applicant: Torquing Technology Limited, Haverfordwest (GB)

(72) Inventor: Ivan Reedman, Haverfordwest (GB)

(21) Appl. No.: 14/384,016

(22) PCT Filed: Mar. 22, 2013
(86) PCT No.: PCT/GB2013/050750

§ 371 Date: Sep. 9, 2014

(30) Foreign Application Priority Data
Mar. 30, 2012 (GB) 1205722.0

(51) Int. Cl. G05B 15/02

(52) U.S. Cl. CPC G05B 15/02
USPC 700/19

(57) ABSTRACT

A heterarchical device control system is provided, comprising a plurality of computer-implemented cells. At least one cell is a control cell having software arranged to communicate instructions to the device being controlled in a language native to the device so as to perform a predetermined task. Also, at least one cell is a sensor cell configured to generate sensor data for input to the control cell to facilitate performance of the predetermined task. The sensor data might be environmentally-related data e.g. position of the device, speed of travel, angle of elevation etc. Messages sent between the cells are formed in accordance with a common format, which might be a high-level programming language, a low level programming language or a protocol. This arrangement provides a fault-tolerant, scalable and autonomous control system.

The invention relates to device control systems. In particular, it relates to heterarchical control systems in which autonomous cells operate both independently and collectively to achieve a task.

Device control systems consist of devices which direct or otherwise influence the activities of other devices. Control systems have proven useful in many industries for a variety of applications, particularly where a physical quantity must be varied due to a set of input parameters. Known applications range from space exploration where radio antennae must be accurately pointed towards Earth, through to the manipulation of robotic arms in automated manufacturing processes.

In relatively recent times, the high speed and low cost of computing technology has lead to the development of computer-implemented (or digital) control systems for a variety of applications. Moreover, the small size of microcomputers has lead to some control systems being embedded within the device(s) that are to be controlled, wherein software executing within the control system uses measurements received from sensors to perform calculations and other operations in the decision-making process directing the behaviour of the device(s). The advance of networking and distributed computing technologies has also had an influence, leading to the development of Networked Control Systems (NCS) wherein control and feedback signals are exchanged among the system's components in the form of information packages travelling through a telecommunications or computer network.

Typically, control systems include four basic types of component:
1. Sensors: for the acquisition of measured data and environmental information required by the controllers;
2. Controllers: to make decisions and to issue commands to actuators based on the data received from the sensors;
3. Actuators: to perform the commands issued by the controllers; and
4. A communication network: to facilitate the exchange of information and instructions between the control system components.

In terms of system architecture, a variety of approaches have been used to combine these components into known control systems. The terms ‘hierarchy’ and ‘heterarchy’ are well known in the field of systems architecture. They are understood to refer to different architectures having different data flows.

### Hierarchical Control Systems

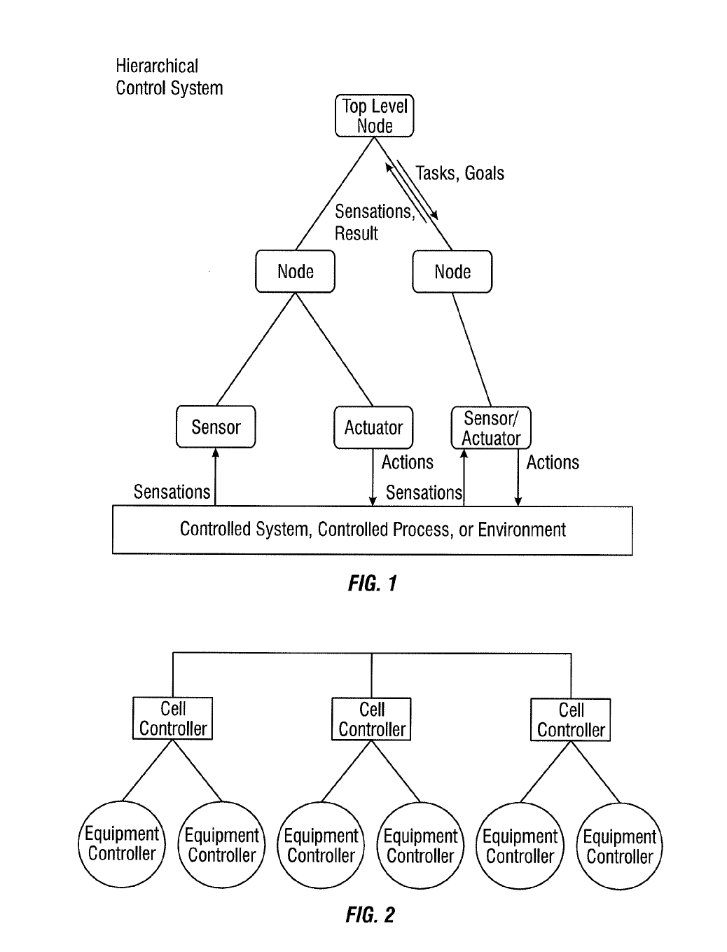

The architecture of a typical hierarchical control system is shown in FIG. 1.

At the time of filing, the Wikipedia entry for ‘hierarchy’ is as follows:

“A hierarchy is an arrangement of items (objects, names, values, categories, etc.) in which the items are represented as being “above,” “below,” or “at the same level as” one another. Abstractly, a hierarchy can be modeled mathematically as a rooted tree: the root of the tree forms the top level, and the children of a given vertex are at the same level, below their common parent.

A hierarchy can link entities either directly or indirectly, and either vertically or horizontally. The only direct links in a hierarchy, insofar as they are hierarchical, are to one's immediate superior or to one of one's subordinates, although a system that is largely hierarchical can also incorporate alternative hierarchies. Indirect hierarchical links can extend “vertically” upwards or downwards via multiple links in the same direction, following a path. All parts of the hierarchy which are not linked vertically to one another nevertheless can be “horizontally” linked through a path by traveling up the hierarchy to find a common direct or indirect superior, and then down again. This is akin to two co-workers or colleagues; each reports to a common superior, but they have the same relative amount of authority. Organizational forms exist that are both alternative and complimentary to hierarchy. Heterachy is one such form.”

With respect to systems architecture, the hierarchical approach is commonly recognised as the most widely employed control system architecture. As explained above, hierarchical systems can be conceptualised as tree structures in which each nodes on each level of the tree operate independently, performing tasks communicated to them from their respective parent nodes (higher up the tree) and, in turn, requiring the performance of tasks by their child nodes (lower down the tree). At the top of the tree is the top level node, which is a central controller which oversees activities within the system. At the bottom of the tree, the terminal (i.e. ‘leaf’) nodes are implemented as sensors or actuators. Each intermediate level in the tree represents another layer of procedural and/or data abstraction.

The data flow in a hierarchical system is top down. Therefore, cell controllers (mid-level nodes that perform control functions for a logical block) in a hierarchical system act as slaves to the system components which are further up the hierarchy. A cell controller accepts tasks from a single parent node, and issues commands to child nodes under its own authority. It reports the results it receives from its child nodes back up the tree to the higher level nodes.

However, hierarchical systems can become very complicated as the number of system components or nodes increase. Each addition of a level of nodes, or branch of the tree, increases the information traffic at higher levels of abstraction (e.g. when the number of pieces of equipment in the shop increases). As a result, the loading on the central controller can become too great and can render such systems prone to a relatively high occurrence of failures or delays in responding to stimuli. In certain applications, the high incidence of failures and relative fault intolerance of the hierarchical model may not be acceptable—failure of a single mid-level controller node renders all functionality below it inoperable.

Examples of known hierarchical systems include: EP 2244148 A1, WO 00/57367 A1, US2004/230980 A, U.S. Pat. No. 5,189,624 A, U.S. Pat. No. 4,896,087 A, and GB 2251316 A. All of these disclosed arrangements are fully hierarchical in their structure and data flow. Moreover, each of these known arrangements operates at the macro (rather than nano) level, and are not inherently fault tolerant.

It is important to note the phrase quoted above in respect of a hierarchical architecture: “the only direct links in a hierarchy, insofar as they are hierarchical, are to one's immediate superior or to one of one's subordinates”. The person skilled in the art of systems architecture and systems design would be well aware of this, and would also appreciate that this contrasts with the architecture of the heterarchical approach as explained below.

### Heterarchical (or ‘Distributed’) Control Systems

The architecture of a typical heterarchical control system is shown in FIG. 2.

The Wikipedia entry for ‘heterarchy’, as retrieved at the time of filing, states that:

“A heterarchy is a system of organization replete with overlap, multiplicity, mixed ascendancy, and/or divergent-but-coexistent patterns of relation.

A heterarchy may be parallel to a hierarchy, subsumed to a hierarchy, or it may contain hierarchies; the two kinds of structure are not mutually exclusive. In fact, each level in a hierarchical system is composed of a potentially heterarchical group which contains its constituent elements . . . . In a group of related items, heterarchy is a state wherein any pair of items is likely to be related in two or more differing ways. Whereas hierarchies sort groups into progressively smaller categories and subcategories, heterarchies divide and unite groups variously, according to multiple concerns that emerge or recede from view according to perspective. Crucially, no one way of dividing a heterarchical system can ever be a totalizing or all-encompassing view of the system, each division is clearly partial, and in many cases, a partial division leads us, as perceivers, to a feeling of contradiction that invites a new way of dividing things.”

Thus, within the heterarchical control architecture the central controller is removed and is replaced by local autonomous components (or ‘cells’) which negotiate and cooperate on an equal status. Thus, instead of planning and dispatch activities being carried out by a central controller, responsibility for these tasks is distributed throughout the heterarchy.

Cell controllers manage the bulk of the information flow occurring between co-operating cells which carry out the local decision making necessary to achieve global tasks.

A criticism of fully heterarchical systems is that the inter-cell communication can become unfeasably ‘busy’, leading to a deadlock situation in which colliding packets of information are unable to pass each other due to the lack of a supervising component to resolve the matter. With a large heterarchy, this can again lead to delayed responses and inefficient information flow due to the flat structure of cells.

### Hybrid Control Systems

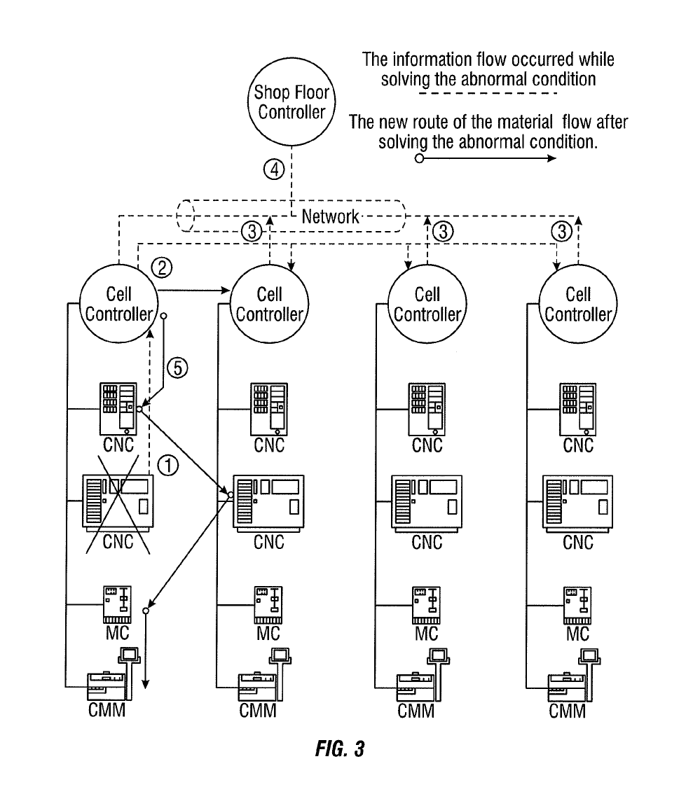

A hybrid hierarchical/heterarchical control system is proposed in C. Ou-Yang and J. S. Lin, “The development of a Hybrid Hierarchical/Heterarchical Shop Floor Control System Applying a Bidding Method in Job Dispatching” (Robotics and Computer-Integrated Manufacturing, Volume 14, Issue 3, June 1998, pp 199 to 217). The architecture of this known hybrid system is shown in FIG. 3.

In this hybrid model, a blend of the heterarchical/hierarchical approaches is employed wherein the shop floor controller is given the responsibility for global tasks, whilst each cell controller is allowed to determine the production schedule of its respective cell. Tasks relating to the cell level (e.g. obtaining jobs dispatching operation tasks to the relevant device or monitoring the process) are performed by the cell controllers. However, the central controller assumes responsibility for higher level tasks affecting a wider range of equipment, such as dispatching orders, handling inter-cell communication and responding to faults or abnormal events.

In order to implement this architecture, a ‘bidding’ process is employed wherein data related to each task is ‘announced’ to each cell controller by the central controller. Each cell controller then submits a ‘bid’ for the task based upon its available resources. The task will be performed by the cell with the lowest bidding price, as assessed by the shop floor controller.

With respect to fault tolerance, we refer to FIG. 3 which shows that when the first line has a fault in the large CNC machine, it then sends data about the job to the other cells. Each cell controller then computes the ‘cost’ of completing the job along with the existing items in its queue and sends this back to the shop floor controller whose task it is to re-assign the job. However, it is clear from FIG. 3 that if a cell controller malfunctions, the functionality of the entire line is lost.

The same fundamental limitations exists with hierarchies, heterarchies and hybrid control system architectures: large control systems require high levels of information traffic at the upper branches of the tree leading to delays; loss of a cell controller results in loss of all functionality below it in the tree; the control system structure is defined at time of design and can not change on-the-fly due to external disturbances.

An improved solution has now been devised.

Thus, in accordance with the present invention, there is provided a heterarchical device control system comprising a plurality of computer-implemented cells, wherein:

messages sent between the cells are formed in accordance with a common format; at least one cell is a control cell having software arranged to communicate instructions to the device being controlled in a language native to the device so as to perform a predetermined task; and
at least one cell is a sensor cell configured to generate sensor data for input to the control cell to facilitate performance of the predetermined task.

Thus, the invention comprises a computer-implemented system of cells arranged and configured to facilitate manipulation or control of at least one device. The device may be any type of device such as, for example, a vehicle or a robot in a production line.

The system may comprise a collection of independent but co-operating components (‘cells’), each cell being computer implemented i.e. having its own processor and software executing on the processor.

Preferably, two or more cells within the system may intercommunicate through more than one path.

Preferably, the cell software comprises instructions relating to the performance of a particular function. Preferably, the cell functionality may be re-defined ‘on the fly’ as required to meet the functional requirements of the system. The functionality of each cell (and thus the entire system) may be implemented by the software provided for execution on the cell processor(s). This provides the benefit that the functionality of the system can be extended by building and/or adding additional cells with software designed to achieve a new, different task.

Moreover, as each cell may have its own processor, the processing resources are distributed throughout the system providing an infinitely scalable system which does not place increased loading upon a centralised CPU as the system expands. The distributed nature of the present invention, combined with the potential for multiple paths for communications traffic, also provides enhanced resilience and fault tolerance in comparison to known architectures.

Preferably, each cell is autonomous in that its software is configured to execute in pursuit of the predetermined task in an independent manner. Thus, the cell may not require continued instructions, input or intervention at run time.

At least one cell may be embedded in or carried upon the device. Preferably, the system comprises at least one control cell and one sensor cell embedded in, mounted on or otherwise connected to the device. Thus, a control cell and a sensor cell may be combined to form a device controller.

The software may be provided to one or more of the cells at run time, for example from another cell, or directly from a user. This allows for changes to functionality for each cell as required.

Alternatively, the software may be provided to the cell prior to run time, by being pre-installed in any form of memory prior to run time. The software may be pre-loaded or saved from a previous operation.

Preferably, the cells are able to communicate with each other via a common (shared) format. That is to say, the communications sent between the cells are constructed in a form which can be understood by all cells. There may be no need for a message to be translated or interpreted upon receipt by a cell, as it can be understood and processed directly by all cells in the commonly agreed format.

The common format may be a language. For example, it may be an artificial language such as a low level programming language. The common format may be machine code or assembly language. Thus, two control cells may ‘talk’ to each other in a common language, both understanding the syntax and relevance of what the other is saying.

The common format may be a protocol. For example, a control cell may communicate with a sensor cell such that data sent between the cells is structured.

Preferably, the software is written in low level programming language (machine code or assembly language) such that the software residing in the cells is not dependent upon any software platform in order to function. Therefore, in contrast to prior art systems, no operating system or supporting software resources are required within the cells. This provides the numerous advantages, including increased execution speeds, reduction in space (storage) requirements within the cells, and enhanced scalability of the system.

A control cell may be provided having software written to enable it to communicate with a sensor cell. Preferably, the control-sensor cell communication is conducted via the common format to allow potential use of sensor data by other cells as required.

Preferably, the control cell is also configured such that it can send instructions to the device so as to control or influence the activities of the device. The instructions may be communicated from the control cell to the device in the common format. Alternatively, the control cell may communicate with the device in a format other than the common format. The non common format may be native to the device. For example, it may be a standard PLC output.

The sensor cell may generate (measure and/or store) data relating to the environment in which the device is located. Preferably, the sensor cell is a different cell from the control cell. The control cell may be in communication with more than one sensor cell.

Thus, a device control system may comprise one or more control cells and one or more sensor cells so as to direct or influence the functionality of the device.

The sensor cell comprises a sensor arranged and configured to measure a parameter. Various types of sensor cells may be provided, for measuring or recording different types of data. For example, the system may comprise a compass, a GPS device, a microwave device, a camera, a touch sensor, a temperature sensor and so on. The invention is not intended to be limited to the type of sensor that may be incorporated into a cell.

Preferably, cells may be logically linked so as to form more complex and sophisticated groupings which are capable of achieving more complex and sophisticated tasks in comparison to individual controller-sensor combinations. Thus, a cluster of cells may be configured for communication with a cluster control cell (which may be referred to as a ‘cluster controller’) to form a logical association of cells. The cluster control cell may comprise software arranged and configured to coordinate the activities of individual cells or groups of cells under its direction and to communicate with other cluster controllers.

Preferably, the cluster control cell is configured to communicate instructions to the cluster. Preferably, this communication is conducted via the common format. Cells within the cluster may also be configured for communication with each other, this communication also being via the common format.

Preferably, data stored on a cell within the cluster may be available to other cells in the cluster or to the cluster control cell.

Preferably, each cell in the cluster may communicate its data to the cluster control cell and/or other cells in the common format.

Preferably, each cell may repeatedly communicate its data to the cluster controller and/or other cells.

Preferably, the data may include a cell identifier and/or a piece of sensor data generated by a sensor. Additionally or alternatively, the data may include data generated as the result of a calculation. Additionally or alternatively, the data may include any other data required by the control cell to facilitate its performance of the task.

Beneficially, the functionality of the system can be extended by adding further cell clusters to provide additional levels of procedural abstraction. Thus, the system may comprise a plurality of controlled devices wherein each device may have at least one control cell embedded within it, connected to it, or carried on it. Clusters may be physically connected or may be physically isolated, but retain one or more communication paths between them. Such a collection of controlled devices may be known as a ‘swarm’.

The activities of the swarm may be directed by a swarm control cell. The swarm control cell may be responsible for providing instructions to one or more cluster controllers or other cells.

The swarm control cell may be provided with software arranged and configured to coordinate the activities of the clusters within the swarm so as to perform a predetermined task. The task may be a higher level task than the tasks performed by the individual cells or lower-level groupings of cells.

The swarm control cell may receive data from one or more cluster control cells or other cells. These communications may be formed according to a common format.

Thus, the system comprises a scalable federation of autonomous cells in communication via a common format (language and/or protocol). Constant or uninterrupted communications between cells, clusters or the swarm is not essential to the function of the system, as each cell or cluster of cells retains autonomy over the tasks allocated to them, with updates to task allocations being possible when communication is established or re-established. This allows each cell to be arranged and configured to perform a low-level task, such that the cells can be logically combined to perform higher-level tasks by functional groupings within clusters, with each level of abstraction performing a task or series of tasks until updated.

Also in accordance with the invention there is provided a method of controlling at least one device, the method comprising the steps of providing, instructing, configuring and/or operating a device control system substantially as described above.

Thus, the method may comprise a method of controlling a device. The method may comprise the step of providing a plurality of cells, wherein:

each cell comprises a processor and software for execution upon the processor; messages sent between cells are formed in accordance with a common format;
at least one cell is a control cell having software arranged to communicate instructions to the device in a language native to the device so as to perform a predetermined task; and
at least one cell is a sensor cell configured to generate sensor data for input to the control cell to facilitate performance of the predetermined task.

These and other aspects of the present invention will be apparent from, and elucidated with reference to, the embodiment described herein.

An embodiment of the present invention will now be described by way of example only and with reference to the accompanying drawings, in which:

FIGS. 1 to 3 show the architectures of control systems known in the art.

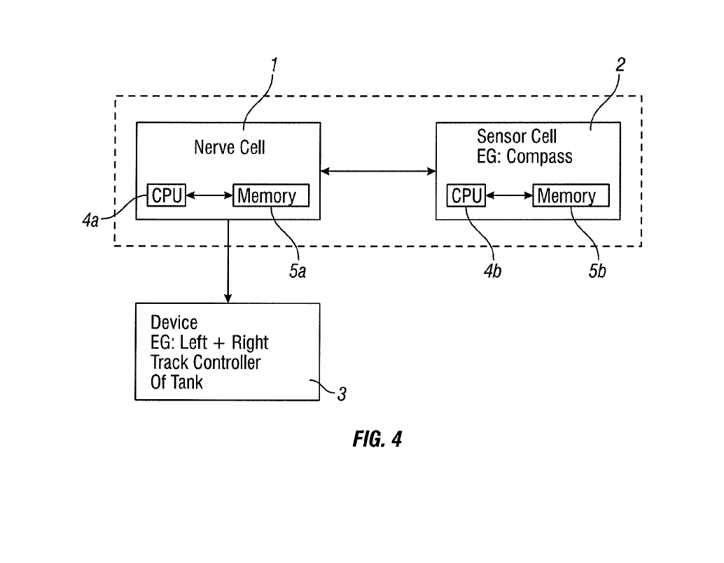

FIG. 4 shows a simple embodiment of the invention comprising a control cell and a sensor cell, co-operating to form a functional control system so as to direct the activities of a tank.

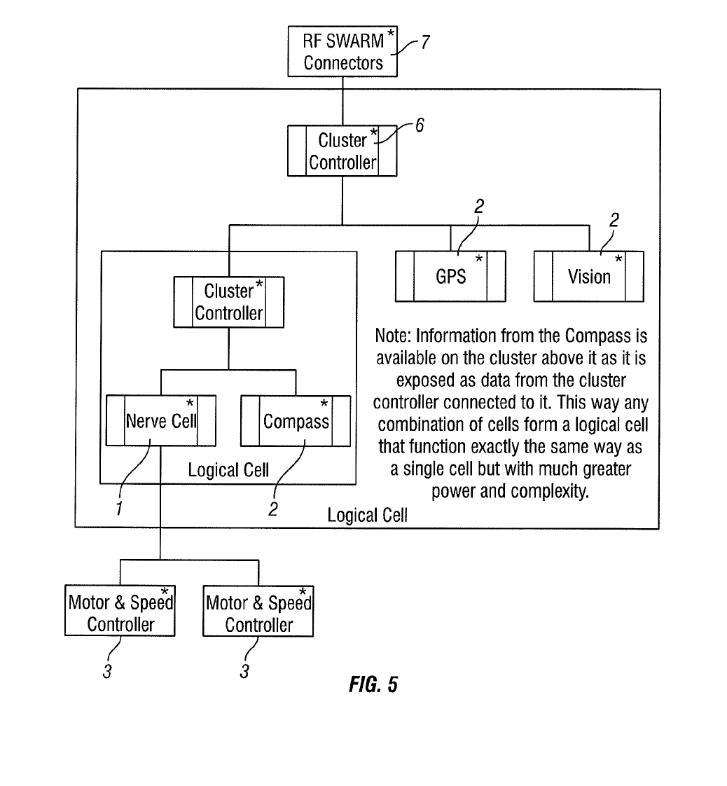

FIG. 5 shows an embodiment of the invention wherein the functionality of the system has been expanded such that the system comprises two logical cells (i.e. ‘clusters’) forming part of a swarm.

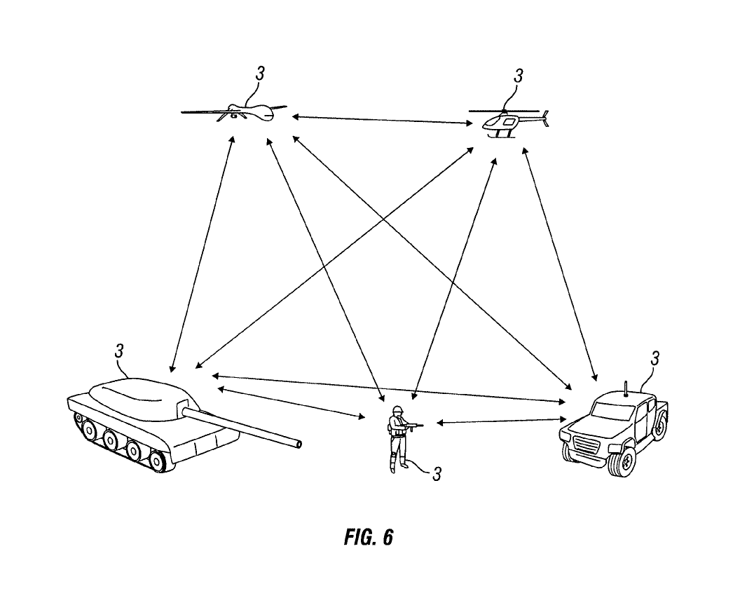

FIG. 6 shows a high-level perspective of a swarm comprising a variety of devices controlled by an embodiment of the invention.

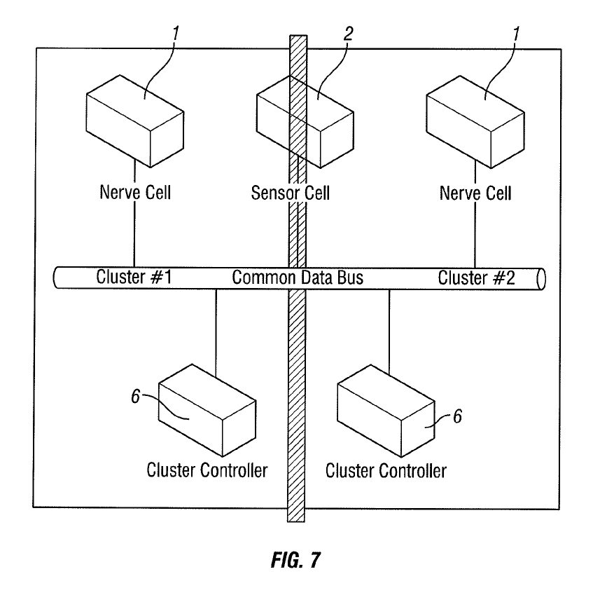

FIG. 7 shows an embodiment of the invention comprising two clusters sharing the same sensor cell and wherein their interfaces are exposed to each other.

The present invention comprises a plurality of basic components (cells) which can be configured in a variety of forms and combined in a variety of ways to form a computer implemented system which is as simple or complex as it needs to be (both physically and logically) in order to achieve a predetermined goal. Each component is an autonomous cell programmed to perform a specific, but changeable, function, whilst sharing its data and cooperating with other cells such that they can act independently as well as collectively.

In some ways, the invention is analogous to an organic system, such as the human body. Different cells perform different roles within the entire organic system, but collectively they function together to form a symbiotic entity. Taking this analogy further, it is possible to view the body from a variety of abstracted levels: at the individual cell level, or as a cluster forming an organ, or at the body level.

According to the present invention, the basic building block of the system comprises a control cell 1 (which may be referred to hereinafter as a ‘nerve cell’) and at least one sensor cell 2. These cells are embedded within, attached to or carried on the device which is to be controlled. In the present illustration, the device is a tank although it should be noted that any type of device could be controlled using a suitably configured embodiment of the invention. This is illustrated in FIG. 4, which shows a nerve cell 1 and a sensor cell 2 in communication so as to control the movement of a device 3 (in this case, the left and right track controller of a tank).

The nerve cell 1 is provided on a motherboard and comprises a processor 4 and software configured to execute upon the processor. Memory 5a is provided for storage of the software and associated data. Instructions and data are fetched from/written to memory 5a during run time as directed by the operations of the processor 4a. Again, this is illustrated in FIG. 4.

The software installed in each nerve cell 1 has been designed with a particular, specific capability in mind and so a system may comprise a variety of nerve cells each designed to provide a different functionality, but each potentially able to take on new functionality during run-time.

Therefore, the nerve cell 1 software comprises instructions pertaining to the accomplishment of a predetermined goal. These instructions could be formatted according to any language or structural scheme. For example, they could be written in a low-level, artificial language. Alternatively, any other language, protocol, rule system or format could be used. Hereinafter, the term ‘language’ will be used to refer to the format for the sake of simplicity.

As all cells are able to communicate with one another using this shared language, it is referred to hereinafter as ‘the common language’. The nerve cell 1 can either be pre-configured by installing the software and/or configuration data in the cell prior to use, or the software may be transmitted to the nerve cell during operation (i.e. at run time).

The nerve cell 1 is able to manipulate and influence the activities of the device 3 by sending instructions to the device's on-board processor. If the invention has been retrofitted to an existing device, this communication between the nerve cell 1 and the device 3 is conducted in the language which is native to the device, rather than in the ‘common language’ used for inter-cell communication. Alternatively, if the device has been designed for use in conjunction with an embodiment of the invention it may be that the nerve cell-device communication is performed using the common language. Communication between the device and the nerve cell could be bi-directional (i.e. the nerve cell may send and receive data to/from the device) or uni-directional (i.e. from the nerve cell to the device only), although FIG. 4 shows only one direction of communication.

As well as communication with the device, the nerve cell is able to communicate with one or more sensor cells 2. The sensor cell also has its own processor 4b and memory 5b. A sensor device is also associated with the sensor cell. Examples of the type of sensor device which may be incorporated into the system include (but are not limited to) a compass, a GPS device, a temperature sensor, a camera, a microwave device, a touch sensor and so on. Thus, each sensor cell 2 is able to generate data relating to the physical environment in which the sensor cell 2 is located—for example, the device's current altitude or exact location, or the ambient air temperature etc. The sensor cell 2 enables the system to interact with the ‘real world’ by providing measured data to one or more nerve cells 1 (and also to other sensor cells 2) so that the data can be processed and used in decision making processes or in the calibration of other sensor cells. This will be described in more detail below.

The sensor cell 2 is able to send its data to the nerve cell 1 for processing. Therefore, the nerve cell 1 is able to react to sensor data and is also able to monitor data generated by other sensor cells within the system.

Although the sensor cell 2 is configured to communicate directly with its associated nerve cell 1, its data is also visible to any other nerve cells within the cluster via routing of communications through other cells and abstraction levels.

As the nerve cell 1 and sensor cell 2 each have their own processors 4a, 4b and communicate in the common language to achieve a given purpose, they form an autonomous building block which is able to function without the need for continued user intervention or continuous communication with other cell clusters.

Moreover, there is no need for a supporting software platform such as an operating system and the conventional utilities and resources. Therefore, the system components are truly ‘platform non-dependent’ in the sense that an underlying layer of utility software is not required for execution of the cell software.

If a new functionality is required within the system, new nerve cells or sensor cells can be quickly and easily implemented and incorporated into the system, providing theoretically limitless functionality and system extensibility.

In its simplest form, the system comprises a nerve cell 1 in communication with a sensor cell 2 to control a device as per FIG. 4. For example, a tank may be fitted with a compass sensor cell 2 and a nerve cell 1, the nerve cell executing instructions to turn the device so that it always faces north based upon the output the nerve cell receives from the compass cell 2. Thus, a nerve cell and a sensor cell can be logically combined to form a basic building block.

However, these basic building blocks can also be used to build larger systems which implement solutions to more complex problems or tasks, as illustrated in FIG. 5. For example, a logically higher level cell (hereinafter known as a ‘cluster controller’ 6) may be used to manage and coordinate one or more nerve cells 1 and sensors 2 (i.e. a logical ‘cluster’ of cells). The cluster controller 6, also having its own processor, memory and software, is able to receive instructions in turn from higher level cells (or directly from a user), and also issue instructions to cells below it in the logical cell.

An individual cell is able to ‘speak’ to other cells and also to the cluster controller 6. Such clusters of cells may also be viewed as ‘super cells’. It should be noted that super cells can overlap—for example, if two or more cluster controllers are configured to interact with the same sensor cell, then two super cells can be seen to share that sensor cell.

Moreover, in the same way as individual cells can be combined to form building blocks which can then be combined under the coordination of a cluster controller so, in turn, clusters can be combined via the use of higher level controllers 7 to accomplish yet more sophisticated tasks. Each higher level controller introduces another level of procedural and/or data abstraction into the federated, heterogeneous control system.

Data generated by cells within a cluster is exposed (i.e. available) to other cells within the group, and is also exposed to higher level clusters via the cluster controller, thus enabling the formation of logical (super) cells which function in the same way as a single cell but with greater complexity.

FIG. 7 shows two separate clusters, shown on left and right sides of the vertical dividing line. The entire capability is exposed as a single entity through the vertical dividing line. As in this example there is a single data bus, the isolation between clusters is logical; both clusters share the same sensor cell and expose their interfaces to each other.

In this way, the use of cluster controllers enables a federated system of cooperating cells to be constructed wherein communication is performed locally within levels of abstraction, each cluster controller providing localised data processing, control and abstraction from the logical layer above it in the system, but working collectively to achieve the desired goal.

Taking this architecture to another level of abstraction, it is possible to combine a plurality of controlled devices, each being manipulated by its own federated system of networked cells as described above, so as to form a ‘swarm’ of devices 3. This is illustrated in FIG. 6. The philosophy and implementation of the swarm is the same as previously described for a cluster.

It should be noted that clusters may share one or more cells. This provides an additional communications path from within a cluster.

An example of an illustrative embodiment in use is now provided.

Upon power up, every cell ‘announces’ itself to the other cells within the system. For each cell, this involves broadcasting its ID, any specific data about itself and its functionality and/or capabilities to the other cells. For example, the cell may announce that it is a nerve cell, identified as cell #40 and that it has control over the left and right track of a tank.

If a cluster controller is present, it receives these announcements and orders itself internally so that it ‘knows’ how to handle the higher level commands it receives and how to implement them based on the cells which reside under it.

Consider the scenario wherein a cluster controller is provided, controlling a nerve cell, and sensor cells having a compass, a touch sensor, a GPS cell and a temperature sensor, respectively. These cells having the following identifiers:

Cluster controller=cell #1
Nerve cell=cell #2
Compass cell=cell #3
Touch sensor cell=cell #4
GPS=cell #5

### Temperature Cell=Cell #6

When the system powers up, every cell from #2 to #6 announces itself to the cluster controller and such that the cluster controller is made aware of each cell's identifier and what (the software of) each cell is configured to do. Thus, the cluster controller is provided with information about the functional cells it has under its control. The cluster controller stores this information about the configuration that exists below it. The cells communicate this information to the cluster controller using a common, shared language or protocol.

During run time, every cell ‘announces’ its data to the cluster controller hundreds of times a second, or as otherwise required. If a particular cell fails to communicate, the cluster controller is able to recover from this fault by requesting that all cells within the cluster announce themselves and their capability. If a cell does not announce itself and its abilities, the cluster controller can notify its parent controller (if there is one) about the error but can also adapt its own behaviour based on its knowledge of the cells which are still in operation.

When each cell announces itself, every other cell is also listening. Some local mapping of sensor types is performed, as discussed in more detail in the example below.

The compass cell communicates directly with its onboard 3 axis magnetometer, and calculates the tan, sin and cos values to output the tank's direction. It repeatedly announces itself to the cluster controller and other cells. For example: I am Cell #3 and I have a value for you of 73 (note: this value could be any value from 0-65535).

The touch sensor deals with the local signal generation and amplification of the strain gauge, and performs any calibration it needs based on temperature (which can be provided by the temperature cell). Suppose that the touch sensor has already been provided with initial configuration data including an instruction to output 0 to full range strain as 0-1000 but calibrate 1 extra unit for every degree Centigrade above 25 and 1 unit less for every degree Centigrade below 25. Suppose also that it now detects that the temperature sensor has announced itself and the sensor cell locks onto the temperature feed. In essence, the sensor cell as undergone an auto configuration process.

In an alternative embodiment, the system could comprise a plurality of temperature sensors and software in each cell could be configured to cause its cell to ‘listen’ to a specific temperature sensor within that plurality. Thus, we could tell Cell #6 (which is a temperature sensor) that it is sensing the temperature of item #50, and then tell the touch sensor that is to monitor the temperature of item #50. In this way, if the temperature cell is replaced and its ID changes, the logical mapping still holds true so that this alteration does not affect the system operation. Therefore, enhanced system scalability is provided in comparison with prior art systems.

Thus, to summarise, the compass cell announces itself many times as “I'm Cell #3 and I have a value for you of 73”, and the touch sensor announces itself hundreds of times as “I'm Cell #4 and I have a value for you of 72”.

Thus, it can be seen that both sensors speak the same language and use the same manner of communication.

The software of the nerve cell could be configured to listen to cell #3 and react in a particular way to its output as priority 1 and listen to cell #4 and react a different way as priority 2. So if priority 1 rule is met, priority 2 rule is then evaluated.

Each Nerve cell can have hundreds of these rules per output. Thus, the logic employed by the system is very simple but by combining these simple rules it is possible to achieve an extremely powerful, reactive and autonomous behaviour even at the lowest nerve cell level. This can then be scaled (infinitely) to provide a super organism.

A GPS cell could operate in a similar manner by announcing itself many times in succession, for example “I'm cell #5, output 1 (which could be altitude) and I have a value for you of 60”. This value could be anything from 0-65535 and its output is based on the configuration data it has been supplied with. By way of example, suppose that the configuration data sets 4000 as 1 k, 0 as sea level and 65535 as 2 k. This results in a curve which has much greater resolution from 1 k to 2 km above sea level than from sea level to 1 km. This might be because a particular mission requires very fine control in the 1 km to 2 km altitude range. However, the nerve cell is not concerned with these considerations as it has been told (by way of the software) how to react to values from each sensor and the priority which should be given to each behavioural instruction.

Continuing the example, the GPS announces “Cell #5, output 2” and so on. In certain embodiments, it may have its outputs calibrated to some other value which another cell is outputting.

This is in contrast to known approaches, in which a component similar to the cluster controller of the present invention (in terms of electronics but not software) communicates directly with the compass, GPS, actuators etc. As a result, the processor of the known system must be scaled up as the sensors become more complex and/or numerous.

Moreover, the processor of the known system must understand the raw data from a compass, the raw data from a GPS and know how to control each actuator.

Advantageously, the system of the present invention can simply be scaled by adding more cells (or logical cells grouped by use of a cluster controller). Every cell has a purpose, knows how to communicate with other cells, and the system is able to configure itself.

Advantages of the present system include:
each specialised nerve cell can both process sensor data from its layer and react locally to coordinate the actions of the device; thus, cells are able to act both independently and collectively to achieve a device-related task;
cells are autonomous—once software has been written for the given task and installed for execution upon a cell's processor, there is no need for further user interaction. The system is able to function independently of the user to achieve its given objective under the direction of the software;
as each cell has its own processor, the processing load is distributed throughout the system and thus no individual cell, group of cells or layer of abstraction is over-burdened with processing responsibilities;
additional cells can be built and added to the system in a modular fashion to extend or tailor its functionality; alternatively, a group of cells can be ‘clustered’ via the use of a controller; thus, the system is (in theory) infinitely scalable;
the system is not platform dependent in that the need for an operating system is obviated;
the system is inherently resilient due to the ability to provide instructions to the cells regarding how to deal with, adapt to and/or recover from cell failures elsewhere in the system.

A comparison of the present invention with the hybrid heterarchy/hierarchy architecture of Ou-Yang and Lin is as follows:
1. The system disclosed in Ou-Yang is a one or two level heterarchy. In order for a many-level system to be built using the disclosed approach, a great deal of re-design and engineering would be required; in contrast, a system according to the present invention can be scaled natively;
2. The cell controller level of Ou-Yang equates to the cluster controller of the presently claimed system, wherein the cluster controller is used to form a super cell. According to the present invention data is natively exposed as required by other cell controllers as though they exist in the same super cell. Thus, the super cells of the invention are an example of federation. This concept allows the data to be exposed natively across as many tiers in the heterarchy as is needed;
3. In FIG. 3, the first line in the Ou-Yang system has a fault in the large CNC machine; it then sends data about the job to the other cells. Each cell then computes the ‘cost’ of completing the job along with the existing items in its queue and sends this back to the shop floor controller to re-assign the job.
   By contrast, if a fault occurs within the presently claimed system, natural resiliency takes over as all the other super cells are exposed as the interface to the super cell with the fault. Thus, jobs do not need to be re-allocated, as initial configuration data can be built into the software to control the behaviour in such circumstances; the super cell with the fault is able to pass its work automatically to a device inside another super cell as the super cell acts as though it is a larger cell;
4. In FIG. 3, the Ou-Yang cell controllers are large computer servers with Operating Systems installed and executing, with a great number of back ground tasks being performed. The operating system handles the required tasking of priorities. However, in accordance with the present invention, the control system operates at a much lower level in this respect, as cells exist at the simplest level and priorities are handled only at the level necessary to manage a task. Thus, the invention enables the construction of powerful and complex solutions using incredibly simple cells, analogous to our natural environment. Instead, while FIG. 3 shows a good heterarchy, it is a heterarchy between large, complex cells and therefore suffers in terms of resiliency at the cellular level. If the Ou-Yang cell controller in FIG. 3 malfunctions, all functionality downstream of the failure point is lost.

In summary, the building blocks of the present invention are very small and simple logical units which allow the rapid and easy construction of a large federated heterarchy control system with inherent resiliency achieved via the use of individual, autonomous cells. This is in contrast to the known approaches which solve their respective drawbacks by incorporating larger processors, additional memory resources, virtualisation techniques or simply bigger servers. Examples of such known prior art systems include: EP 2244148 A1, WO 00/57367 A1, US2004/230980 A, U.S. Pat. No. 5,189,624 A, U.S. Pat. No. 4,896,087 A, and GB 2251316A.

In addition, high levels of fault tolerance are provided through multiple self-healing communications paths throughout the control system, allowing bypass of fault points. This is not possible using traditional control system architectures, other than through the provision of redundant components, thus further increasing system complexity and managerial overheads.

Another way of viewing the difference between the known approaches and that of the present invention is that if one considers the components of the present invention, the same logic flow is observed from the macro to the micro level. However, when one considers the prior art systems the logic flow is very different at each level.

It should be noted that the above-mentioned embodiments illustrate rather than limit the invention, and that those skilled in the art will be capable of designing many alternative embodiments without departing from the scope of the invention as defined by the appended claims. For example, the invention is not intended to be limited with respect to:
the type of device or devices controlled by the system;
the type of sensor device used within a sensor cell;
the type of control cell or native software used within the control cell;
the number of cells or clusters within the system.

In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A heterarchical device control system comprising a plurality of computer-implemented cells, wherein:
at least one cell is a control cell having software arranged to communicate instructions to the device being controlled in a language native to the device so as to perform a predetermined task;
at least one cell is a sensor cell configured to generate sensor data for input to the control cell to facilitate performance of the predetermined task; and
messages sent between the cells are formed in accordance with a common format.

2. The device control system according to claim 1, wherein the common format is a high-level programming language, a low level programming language or a protocol.

3. The device control system according to claim 1, wherein the sensor data relates to the environment in which the device is located.

4. The device control system according to claim 1, wherein the software executing within the cell is not dependent upon any software platform.

5. The device control system according to claim 1, wherein at least one cell is embedded in or carried upon the device.

6. The device control system according to claim 1, wherein the sensor cell is a different cell from the control cell.

7. The device control system according to claim 1, wherein the device native language is not the same as the common format.

8. The device control system according to claim 1, wherein the device native language is the same as the common format.

9. The device control system according to claim 1, wherein the sensor cell comprises a sensor arranged and configured to measure a parameter.

10. The device control system according to claim 1, wherein the sensor cell is selected from the group consisting of a compass, GPS device, a touch sensor, a camera, and a temperature sensor.

11. The device control system according to claim 1, wherein the software is provided to at least one cell at run time.

12. The device control system according to claim 11, wherein the software is provided from another cell or directly from a user.

13. The device control system according to claim 1, wherein the software is provided to at least one cell prior to run time.

14. The device control system according to claim 1, wherein each cell in the plurality of cells is autonomous such that user input is not required at run time in order for the system to perform the predetermined task.

15. The device control system according to claim 1, further comprising a plurality of devices to be controlled, each device having at least one control cell and one sensor cell embedded within it or carried on it.

16. The device control system according to claim 1, wherein a cluster of cells is configured for communication with a cluster control cell to form a logical association of cells, the cluster being arranged and configured to perform a pre-determined task.

17. The device control system according to claim 16, wherein the cluster comprises a plurality of sensor cells and/or a plurality of control cells.

18. The device control system according to claim 16, wherein the cluster control cell comprises software arranged and configured to coordinate the activities of the cells within the cluster.

19. The device control system according to claim 16 wherein:
the cluster control cell is configured to communicate instructions to the cells within the cluster; and/or
cells within the cluster are configured for communication with each other; and/or
data generated by a cell within the cluster is communicated to other cells in the cluster and/or to the cluster control cell.

20. The device control system according to claim 16, wherein a plurality of clusters is provided to form a logical swarm, at least one communication path being provided between the clusters in the plurality.

21. The device control system according to claim 20, wherein a swarm control cell is provided comprising software arranged and configured to coordinate the activities of the clusters so as to perform a pre-determined task.

22. The device control system according to claim 21, wherein the software of the swarm control cell is arranged and configured to communicate with the cluster control cell and/or other cells within each clusters.

23. The device control system according to claim 20, wherein at least two clusters in the plurality are physically connected to one another, or are physically isolated from one another.

24. The device control system according to claim 1, wherein the system architecture comprises a scalable federation of autonomous cells in communication via the common format, each cell being arranged and configured to perform a low-level task, such that the cells can be logically combined to perform higher-level tasks.

25. A method of controlling at least one device of claim 1, the method comprising one or more steps of providing, instructing, configuring and operating the device control system according to claim 1.
